(19) United States
(12) Patent Application Publication
(10) Pub. No.: US 2010/0133063 A1
(43) Pub. Date: Jun. 3, 2010

(54) DEVICE FOR DAMPING VIBRATIONS, IN PARTICULAR A MULTI-STEP TORSIONAL VIBRATION DAMPER

(75) Inventor: Mario Degler, Baden-Baden (DE)

Correspondence Address: SIMPSON & SIMPSON, PLLC, 5555 MAIN STREET, WILLIAMSVILLE, NY, 14221-5406, US

(73) Assignee: LUK LAMELLEN UND KUPPLUNGSBAU BETEILIGUNGS KG, Buehl (DE)

(21) Appl. No.: 12/697,761

(22) Filed: Feb. 1, 2010

Related U.S. Application Data
(63) Continuation of application No. PCT/DE2008/001223, filed on Jul. 24, 2008.

(30) Foreign Application Priority Data
Aug. 2, 2007 (DE) 10 2007 036 193.0

(51) Int. Cl. F16F 15/10

(52) U.S. Cl. 192/30 V

(57) ABSTRACT

A vibration damping device, including at least two damper assemblies connected in parallel, disposed coaxially, each damper assembly comprising at least one input component and one output component, a first damper assembly of the at least two damper assemblies comprising at least two dampers connected in series and coupled through an intermediary flange, and a second damper assembly of the at least two damper assemblies configured with relative rotation clearance, wherein the output component of the first damper assembly forms a unit with the output component of the second damper assembly, and the first and the second damper assemblies are radially disposed in radial direction on different diameters.

### CROSS-REFERENCE TO RELATED APPLICATIONS

This application is filed under 35 U.S.C. §120 and §365(c) as a continuation of International Patent Application PCT/DE2008/001223, filed Jul. 24, 2008, which application claims priority from German Patent Application No. DE 10 2007 036 193.0, filed on Aug. 2, 2007, which applications are incorporated herein by reference in their entireties.

### FIELD OF THE INVENTION

The invention relates to a device for damping vibrations, in particular a multistage torsion vibration damper, comprising at least two parallel connected, coaxially disposed damper assemblies, a first damper assembly and a second damper assembly.

### BACKGROUND OF THE INVENTION

Vibration damping devices, in particular provided as multistage torsion vibration dampers are known in the art in many embodiments. When disposed in a drive train of a vehicle, they function, viewed in the direction of the force flow, as an elastic clutch between an input and an output and are coupled to the connection elements forming the input and the output. The device transfers torque and simultaneously compensates vibrations occurring during power transmission. Also an embodiment as an absorber is conceivable. In this case the device does not transfer any torque between the adjacent connection elements, but only torque spikes are reduced through the particular components. Such vibration damping devices are based on different functional principles depending on the type of damping. Besides purely mechanical damping solutions also hydraulic damping solutions and combined mechanical-hydraulic damping solutions are known. Mechanical dampers comprise a rotating component which can have one or several components and which functions as an input component or output component of the vibration damper depending on the direction of the force flow, in particular a primary component and a secondary component which are disposed coaxial to one other and which are rotatable within limits in circumferential direction relative to one another. The coupling between the input component and the output component is performed through torque transfer devices and vibration damping devices which are typically formed by spring units and which comprise at least one spring element provided as a compression spring. Vibrations can be compensated and reduced through the size of the relative rotation angle between the input component and the output component and the spring force.

From the published document DE 30 47 039 A1 an embodiment of a device of this type for damping vibrations and for transmitting torque between an input and an output is known which comprises two damper assemblies connected in series. In order to facilitate a larger relative movement between the driving and driven elements of the vibration damper, the device is provided with two stages. Thus the device comprises two concentric circles of damping springs which are configured in a housing and which are driven by drive lugs which are mounted in a drive element, e.g. a piston plate for a lock up clutch. Thus floating elements separate the springs in the inner and outer spring circles into two or more groups of springs. Thus, the two or more groups of springs function in parallel to one another in each circle, while the springs in each group function in series. Thus the power transfer in the force flow is performed in series. The inner damper does not have any relative rotation clearance, this means it is effective all the time.

From the published document US 2004/0216979 A1 an embodiment of a vibration damper is known comprising at least two damper assemblies which are connected in parallel, wherein both damper assemblies are effective continuously. The damper assembly for the smaller rotation angles is disposed on a radially inner diameter, while the greater rotation clearance is implemented through the second damper assembly on a radially outer diameter. The radially inner damper assembly is configured as a series damper, comprising spring elements separated by a single component flange and connected in series.

From the published document U.S. 2004/0185940 a vibration damping device is known which is configured as a series—parallel damper comprising a first rotating element and a second rotating element which are rotatable relative to one another within limits. Furthermore the device comprises a pair of first elastic elements oriented in one rotation direction and connected in series, which are coupled through a floating intermediary flange and another second elastic element, which is connected in parallel to the first elastic elements wherein the second elastic element is configured, so that it is compressed in the rotation direction after the pair of first elastic elements is compressed to a first angle due to a relative rotation of the first rotating element and the second rotating element. For this purpose a clearance angle is associated with the second elastic element, which clearance angle in integrated in the rotating flange. The disposition of first and second elastic elements is provided overlapping for reducing the radial installation space to one diameter or in radial direction with respect to the annular portions theoretically created through the extension of the spring elements. The coupling between the first elastic elements is performed through a floating flange.

Another embodiment of series-parallel damper device is known form the published document U.S. Pat. No. 3,138,011. The damper described therein includes a drive flange, which is configured integral, however its fabrication and configuration is very complex

All cited embodiments have in common that the spring characteristic is adapted with respect to a desired property in a particular operating range.

### BRIEF SUMMARY OF THE INVENTION

It is the object of the invention to provide a device for damping vibrations with a low spring constant for small torques, which is characterized by a rather flat characteristic diagram. This portion of the characteristic diagram, which can be configured to transfer a portion of the maximum torque shall de definable by a maximum relative rotation angel range between the rotating elements functioning as input- and as output components. The solution according to the invention shall be characterized by low design complexity and low manufacturing complexity and shall further be suitable for integration in force transmission devices for applications in drive trains, wherein the vibration damping device shall require little radial and axial installation space.

The solution according to the invention is characterized by the features of claim 1. Advantageous embodiments are described in the dependent claims.

A vibration damper, in particular a multistage series-parallel torsion vibration damper, comprises at least two parallel connected and axially disposed damper assemblies comprising at least one input component and one output component, a first damper assembly and a second damper assembly comprising torsional clearance, wherein one of the damper assemblies is configured as a series damper, comprising two particular dampers, at least connected in series and coupled over an intermediary flange. The disposition of the first damper assembly according to the invention is provided according to the invention on a diameter in radial direction, which is greater than the diameter at which the second damper assembly is disposed. The output component of the first damper assembly and the output component of the second damper assembly form a structural unit.

The solution according to the invention facilitates, on the one hand, to provide a very compact combined damper assembly, in which the vibration damper is characterized by a spring constant which is as low as possible in a relative rotation angle range which is as large as possible, and the vibration damper is characterized by low friction. Due to the functional concentration in particular components, the production is relatively simple and economical.

The second damper assembly is thus disposed at a distance to the rotation axis which is as small as possible. Both damper assemblies are disposed coaxial to one another and can be disposed in axial direction with an offset or preferably in a plane. In the latter case where the damper assembly is configured as a multistage damper, for which the characteristic diagram can be variably adjusted based on the separate configuration of the particular damper assembly, the damper assembly requires rather little installation space in axial direction and also in radial direction.

Based on the disposition of the first damper assembly in radial direction outside, it can provide rather large relative rotation angles, wherein the first damper assembly is effective in this rotation angle range, and thus a damping can also be provided for higher torques. In a particularly advantageous embodiment, the first damper assembly comprises at least two dampers connected in series, a first and a second damper, wherein the respective output component of one damper forms the input component of the other damper, or is connected torque proof therewith. According to a particularly advantageous embodiment, thus the series damper is implemented on a common diameter, this means the two particular dampers are disposed on a common diameter and do not have any offset in radial direction. In this case, the radial dimensions for the entire damper can be kept small.

Each of the particular dampers of a series damper assembly thus preferably comprises identically sized means for torque transmission and/or means for damping coupling. Thus, it is possible to also implement an independence from the direction of the relative rotation angle when the integration into the entire system is performed accordingly, and in any case, to transfer the torque through the output of the first damper assembly in combination with the torque conducted through the second damper assembly to an element which needs to be driven in a drive train.

According to another embodiment, it is also conceivable to dispose the particular dampers of the first damper assembly on different diameters; in this case, theoretically also the transmission elements can be configured differently.

The particular dampers of the first damper assembly configured as series damper are coupled with one another through an intermediary flange, which can be configured as a drive disc or as a floating flange depending on the connection. Thus, the intermediary flange is configured as an annular element with protrusions forming stop surfaces oriented at the inner circumference in the direction towards the rotation axis, and aligned in circumferential direction for the devices for torque transmission and damping coupling.

Another flange is disposed radially within the extension of the intermediary flange, which is configured as an annular element with protrusions at the outer circumference aligned in radial direction. This annular element functions as an input or output component for the second damper assembly depending on the connection.

The relative rotation clearance of the second damper assembly is characterized by a relative rotation angle defining a clearance angle between the input component and the output component of the second damper assembly, in which the second damper assembly is not effective. The rotation angle is integrated into the output component.

Each of the particular damper assemblies viewed in force flow direction comprises a primary component functioning as input component and a secondary component functioning as output component. The function can be exchanged depending on the force flow direction and the change of the force flow direction, this means the function changes. Thus, the input and output components can be configured integrally or in several components. Preferably, respective integral embodiments are configured disc shaped. They are coupled through torque transmission means and damping coupling means. The torque transmission means and damping coupling means are formed by elastic elements, in particular spring units. Thus, the particular spring units are configured as particular springs, but spring units connected in series can also be provided. The particular damper assembly thus functions as elastic clutch, which transfers torque and compensates vibrations simultaneously. The first damper assembly comprises at least an input component and an output component. The same holds for the second damper assembly, wherein, however, the input component of the first and the second damper assemblies are coupled with one another or connected in parallel, so that a torque split can be provided through the two damper assemblies.

In order to implement the parallel connection, the input components and the output components of the particular damper assemblies form a structural unit, this means, e.g., they can be coupled torque proof with one another. In this case, the particular input and output components are configured as separate elements, which are only functionally coupled with one another through the connection. According to a particularly advantageous embodiment, however, an integral configuration is desired, this means the input component and the output component of the first and second damper assemblies are integrally configured respectively, this means the elements of the first damper assembly forming the input component or the output component are simultaneously configured as input component or output component of the second damper assembly.

The device is configured as a mechanical friction damper. In the simplest case, it comprises two side discs disposed in axial direction and coupled torque proof with one another, which can function as drive discs or output components. The side discs thus comprise openings configured in circumferential direction for receiving and configuring stop surfaces configured opposite to one another for the spring elements of the particular damper assemblies and the dampers of the first damper assembly. Thus, the recesses or pass-through openings forming the stop surfaces in circumferential direction are configured relative to one another, so that a clearance angle, this means a relative rotation range between the input and the output components can be implemented for the second damper assembly, which does not show any effect with respect to the second damper device, this means the second damper device only becomes effective when a particular predefined relative rotation angle is achieved between input component and output component.

This statement also applies analogously for the flange disposed between the two side discs, in particular the disc shaped element provided as a flange, which simultaneously forms the output component of the first and the second damper assembly.

Depending on the association and coupling or connection of a force transmission unit, the various elements can respectively function as input component. This depends on which elements are coupled with the input assembly and which are coupled with the output side in force flow direction. According to a first embodiment, the input can be implemented through side discs. In this case, they are coupled at least indirectly torque proof with a driving element, e.g., a force transmission device, a lockup clutch or a drive engine. The power transmission is then performed in the first damper assembly onto the intermediary flange, and from the intermediary flange onto the flange, which forms the output component of the device and the output component of the second damper assembly.

According to a second embodiment, it is also conceivable to introduce the power through the flange. In this case, the power transmission is performed onto the side discs of the first and the second damper assembly, which function as an output components.

The solution according to the invention is not limited to the embodiment described. Engineering details are at the discretion of a person skilled in the art.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1a illustrates the basic configuration and the basic principle of a vibration damping device according to the invention configured as a series parallel damper in a simplified schematic depiction;

FIGS. 1b and 1c illustrate a vibration damping device according to the invention as a two-stage series vibration damper with reference to two views, in particular an axial sectional view B-B according to FIG. 1b;

FIG. 2 illustrates the embodiment of the side discs of the damper assembly in a side view; and

FIG. 3 illustrates the characteristic diagram of a multistage vibration damping device according to the invention.

### DETAILED DESCRIPTION OF THE INVENTION

At the outset, it should be appreciated that like drawing numbers on different drawing views identify identical, or functionally similar, structural elements of the invention.

While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

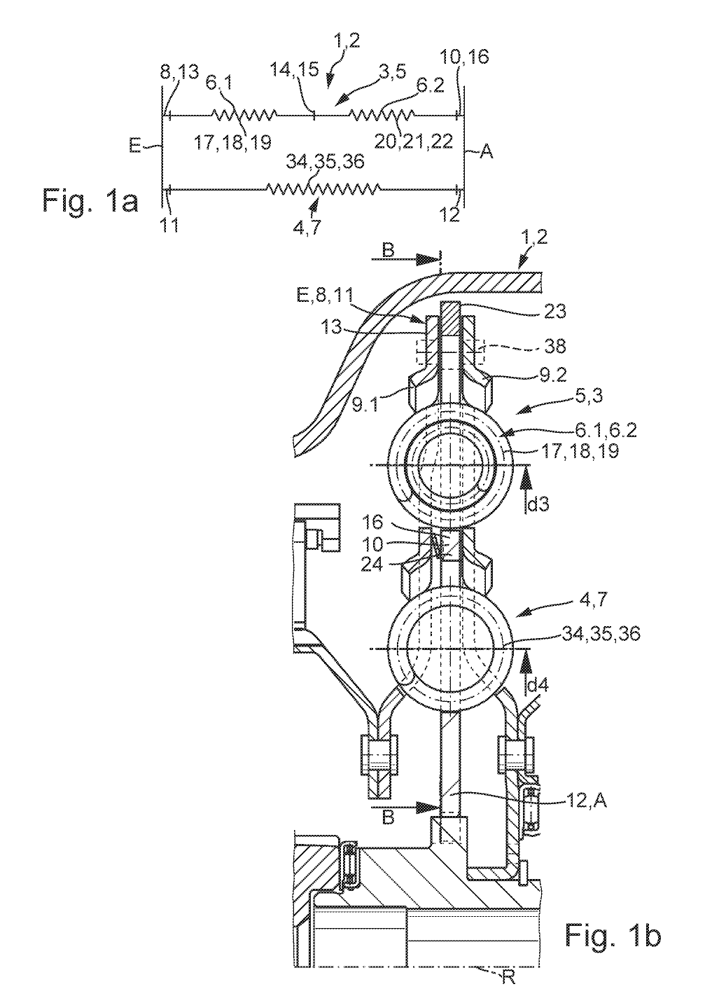

FIG. 1a illustrates the basic configuration and the basic principle of a vibration damping device 1 according to the invention in a simplified schematic depiction, in particular of a torsion vibration damper. The vibration damping device 1 according to the invention is configured as multistage series-parallel damper.

The vibration damper device 1 functionally comprises two damper stages 3, 4, respectively formed by a damper assembly, a first damper assembly 5 and a second damper assembly 7, and which are connected in parallel. Thus, connected in parallel means, that the two damper assemblies 5 and 7 are disposed in the force flow in parallel. The force flow occurs in parallel or through both damper assemblies 5 and 7. The first damper assembly 5 is thus configured according to the invention as a series damper; this means it comprises at least two dampers 6.1 and 6.2 connected in series. Thus, connected in series means that the power transmission in the force flow is performed in series, in particular both dampers 6.1 and 6.2 in the damper stage 3 are passed in sequence, wherein the direction of the dependency is determined by the direction of force induction. In FIG. 1a, the force flow is performed e.g. through the damper 6.1 and 6.2.

Each damper stage 3 and 4 is thus effective in different operating ranges. In particular, the damper assembly 7 of the second damper stage 4 is configured so that it only becomes effective after a predefined relative rotation angle F, which is also designated as clearance angle. Both damper assemblies 5 and 7 are disposed in parallel with one another, and combined into the two-stage series-parallel damper. Each of the particular damper assemblies 5 and 7 comprises rotating elements configured in one or plural components and operating as input components and output components viewed in force flow direction, which rotating elements are coupled with one another through means for torque transmission. Preferably, the torque transmission devices and the damping coupling devices are formed by the same units, preferably spring units, when mechanical damping concepts are implemented. Thus, the input and output components of the particular damper assemblies 5, 7 and of the particular dampers 6.1, 6.2 of the damper assembly 5 are respectively disposed coaxial with one another, and rotatable in circumferential direction within limits relative to one another. The term “input” and “output” component thus viewed in force flow direction relates to the force flow when disposed in a drive train from a driving component to a driven component. The functions as an input component and as an output component can thus be associated with different operating conditions, this means when used in vehicles in drive trains, elements functioning in traction operation, which can be coupled with a drive engine as an input component, while a function reversal occurs in coasting operation, since the element functioning as an output component in traction operation now functions as an input component.

The device 1 comprises an input component E and an output component A viewed in force flow direction. The input component E is thus formed by an element of the damper assembly 5 and of the damper assembly 7 as a structural unit, or the input components of the damper assemblies 5 and 7 are connected torque proof with one another. The damper assembly 5 comprises an input component 8 and an output component 10. The damper assembly 7 comprises an input component 11 and an output component 12. Thus, the input components 8 and 11 are preferably formed directly by the input component E and the output component A. In the first damper assembly 5, two dampers are connected in series, the damper 6.1 and the damper 6.2. Thus, the input 8 of the first damper assembly, which is connected torque proof with the input E of the complete unit, and preferably formed by it directly, is formed by the first damper 6.1. The first damper 6.1 furthermore comprises an output component 14, which simultaneously forms the input component 15 of the second damper 6.2 of the two dampers of the damper assembly 5 connected in series, or connected torque proof therewith. The second damper 6.2 furthermore comprises an output component 16 which forms the output component 10 of the damper assembly 5, and which is connected torque proof with the output A or forms this output. The first damper 6.1 comprises devices 17 for torque transmission between the input component 13 and output component 14 and devices 18 for damping devices coupling. Analogously, the second damper 6.2 comprises devices 20 for torque transmission and devices 21 for damping coupling. The second damper assembly 7 comprises at least one damper, in which the input component 11 and the output component 12 are coupled to one another through torque transmission devices 34 and damping coupling devices 35. The force flow is performed between the input component E and the output component A of the device depending on the direction of rotation in the first damper assembly 5 through the damper 6.1 and the damper 6.2 or vice versa, and simultaneously after reaching the predefined relative rotation angle between the input component E and the output component A, the damper assembly 7.

In FIG. 1a, it is not illustrated in the basic principle that the second damper assembly 7 does not become effective immediately, when a rotation angle between input component E and output component A occurs, but only after reaching a particular relative rotation angle between the input component E and the output component A. This angle is also designated as clearance angle. When it is reached, the second damper stage 4, which is formed by the second damper assembly 7, is engaged.

The FIGS. 1b and 1c illustrate a vibration damping device 1 configured according to the invention, in particular a multistage series-parallel damper assembly in two views. FIG. 1b illustrates the device 1 for damping vibrations in an axial sectional view. FIG. 1c illustrates a view B-B from the right. In this view, in particular the configuration of the flanges 23, 24 is illustrated in neutral position, thus without torque.

The disposition of the first damper stage 3 is performed in radial direction with reference to the rotation axis R of the device 1 on a larger diameter d3 than the second additional damper stage 4 on d4. Thus, the disposition of the first damper assembly 5 is performed on the radial outside, while the disposition of the second damper assembly 7 is performed within the extension of the inner diameter of the damper assembly 5 and thus on a smaller diameter d4. The input component E of the device 1 and thus the input components 8, 10 of the damper assemblies 5, 7 are formed by two drive discs 9.1 and 9.2 disposed adjacent to one another with an offset and configured coaxially with one another, which are coupled with one another torque proof. The output component 10 is disposed between the drive discs 9.1 and 9.2, which output component is connected torque proof with the output component 12 of the damper assembly 7, or forms preferably a structural unit therewith and simultaneously forms the output A. The first damper assembly 5 is comprised of the two dampers 6.1 and 6.2. The numbering of the input and output components according to FIG. 1a is maintained. The input component 13 of the first damper 6.1 is thus formed by the drive discs 9.1 and 9.2. This applies analogously also for the input component 11 of the second damper assembly 7, wherein the input component is also formed here by the drive discs 9.1 and 9.2, or by elements coupled torque proof to the drive discs. The first damper includes devices 17 for torque transmission between the input component 13 and the output component 14 and devices 18 for damping coupling, wherein herein the devices 17 and the devices 18 are formed by a structural unit, in particular a spring unit 19 including at least one spring element in the form of a compression spring. Analogously, also the second damper 6.2 comprises devices 20 for torque transmission and devices 21 for damping coupling, wherein these devices are formed by another spring unit 22. The input component 13 is formed by the drive discs 9.1 and 9.2 as stated supra, the output component 14 is formed by a so-called floating intermediary flange 23, which does not have a support of its own nor a torque proof connection to a connection element. The intermediary flange 23 forms the input component 15 of the second damper 6.2. The output component 16 of the second damper 6.2 and thus the output component 10 or A of the device 1 is formed by a flange 24. The devices 17 and 18 or the particular spring units 19 of the first damper 6.1 are supported at the drive discs 9.1 and 9.2, the flange 24 or the intermediary flange 23, while the spring units 22 of the second damper 6.2 can also be supported at the drive discs 9.1, 9.2 or the intermediary flange 23 and the flange 24 in circumferential direction.

The intermediary flange 23 is configured as a floating flange in this embodiment, this means it does not have a support of its own, and is only formed by the spring units 19, 22, and the disposition of the flange 24 or the side discs 9.1 and 9.2 between the spring units 19, 22.

The intermediary flange 23 is configured as an annular element, which comprises protrusions 25 at its inner circumference, which are oriented towards the rotation axis R, which protrusions comprise stop surfaces 26 and 27 oriented in circumferential direction and facing one another, which stop surfaces are used for the spring units 19 or 22 of the dampers 6.1 and 6.2.

Thus, the flange 24 forms the output components 10, 12 of the first damper assembly 5 and also of the second damper assembly 7, and thus also the output component A of the entire device 1 for damping vibrations. Thus, the output component is configured as a disc shaped element.

The embodiment illustrated in FIG. 1c the intermediary flange 23 is a radially outer intermediary flange which comprises protrusions at its inner circumference 28, which are configured with even spacing from one another in circumferential direction. The flange 24 which forms the output component 10 or 12 of the damper assemblies 5, 7 is configured as a radially inner flange, and is oriented at its outer circumference 29 in radial direction outward, this means it includes protrusions 30 extending away from the rotation axis R and disposed in circumferential direction with an even offset from one another, wherein two adjacent protrusions define circumferentially extending recesses open towards the edge, in which recesses the two spring units 19 and 22 of the particular dampers 6.1 and 6.2 are disposed, and supported at opposite lateral surfaces 31 and 32 of such recess at the flange 24. The flange 24 furthermore comprises recesses 33 on its diameter d4, which recesses are provided in the form of circumferentially extending openings, which comprise support surfaces 37.1, 37.2 for the spring units 36 of the devices 34 for torque transmission or 35 for damping coupling. The support surfaces 37.1, 37.2 are disposed opposite to one another in circumferential direction. These support surfaces 37.1, 37.2, however, only become effective after a defined relative rotation angle, which is e.g. 30 to 50°. The spring units 36 are supported at the side discs 9.1 and 9.2 and the flange 24.

In this embodiment, torque is introduced when used in drive trains and vehicles in normal traction operation viewed in force flow direction from the drive engine to a subsequent power transmission device, through the drive discs 9.1 and 9.2 which are coupled torque proof with one another, wherein according to FIG. 1c, depending on the rotation direction, the spring units 19 or 22 are loaded, which in turn load in particular the protrusions 25 through the stop surfaces 26 or 27, and transfer torque through the coupling caused thereby, while simultaneously coupling the damping through the intermediary flange 23 and the additional spring unit thus e.g. the spring unit 22, and there from onto the flange 24 which forms the output component A. When a relative rotation between the drive discs 9.1, 9.2 and the flange 24 in the amount of the clearance angle F is provided, also the second damper stage 4 becomes effective. After reaching this clearance angle F, the power transmission is additionally performed through the second damper stage 4, also onto the output 12 of the second damper stage 4 functioning as an output component A of the entire device. The particular spring units 19, 22, 36 are provided herein e.g. in the form of so-called compression springs or as coil springs. Other embodiments of elastic elements are theoretically conceivable as well.

The configuration of the torque proof coupling between the drive discs 9.1 and 9.2 of the damper assembly 5 can be performed in a different manner. In the illustrated embodiment, mounting elements 38 are provided preferably in the form of rivets. These can be disposed radially outside of the radial extension of the spring units 19, 22 of the damper stage 3, as illustrated in FIG. 1b. Furthermore, the arrangement can be provided radially outside of the outer diameter of the intermediary flange 23. The torque proof coupling can simultaneously form a stop in circumferential direction and thus a rotation angle limitation for the intermediary flange 23 or the flange 24.

An additional torque proof coupling of the drive discs for the second damper stage and thus the damper assembly 7 can be omitted based on the integral configuration of the input components 8 and 10 of the two damper stages 3, 4.

The embodiments according to the FIGS. 1b and 1c furthermore illustrate a disposition of the particular damper stages 3 and 4 in an axial plane, which is implemented in particular through the configuration of the output component 10 or 12 functioning as output component A of the device 1 of the two damper assemblies 5 and 7. This output component as recited supra is configured as a disc shaped element in the simplest case.

Other embodiments with an offset are also conceivable. In this case, however, at least the flange 24 has to be configured accordingly and the drive discs 9.1 and 9.2. The embodiment illustrated in FIG. 1, however, constitutes a particularly advantageous embodiment with respect to the installation space requirements. This also applies analogously for the configuration of the two dampers 6.1 and 6.2 in radial direction, and in axial direction relative to one another. They are preferably disposed on a common diameter d3 in radial direction without an offset, and they are also disposed in one plane in axial direction. Thus, the series-parallel damper assembly can be implemented through a high degree of functional concentration with minimal installation space.

The protrusions 30 at the outer circumference of the flange 24 also comprise stop surfaces 39.1, 39.2 which interact with stop surfaces 40.1, 40.2 accordingly configured at the inner circumference of the intermediary flange 23 and oriented in circumferential direction opposite to the stop surfaces 39.1, 39.2. The stop surfaces 40.1, 40.2 form a blocking protection for the spring units 19, 22 in the first damper assembly 3. The stop surfaces 39.1, 39.2, 40.1, 40.2 are disposed so that they only form a relative rotation angle limitation between the intermediary flange 23 and the flange 24 at a particular predetermined spring travel.

In the embodiment illustrated in FIG. 1, the drive discs 9.1 and 9.2 function when used in a force transmission device in drive trains for vehicles as an input component E and the flange 24 operates as an output component A. When the force flow is reversed, the function of the input component E is associated with the flange 24 while the drive discs 9.1, 9.2 then function as an output component A. When such a device in a drive train is coupled in both force flow directions respectively with respect to the input and output component with respective driving and driven components, torque is always simultaneously transferred with this device. In one functional condition, e.g. in coasting operation, no coupling is provided with one of the elements forming the input component E or the output component A. The device 1 operates as an absorber, this means it compensates vibrations, but it does not transfer torque like an elastic clutch.

FIG. 1 illustrates a device suitable for applications in force transmission devices for vehicles comprising a hydrodynamic component and a lockup device for the hydrodynamic component, which is disposed in series to the hydrodynamic component and also to the lockup device.

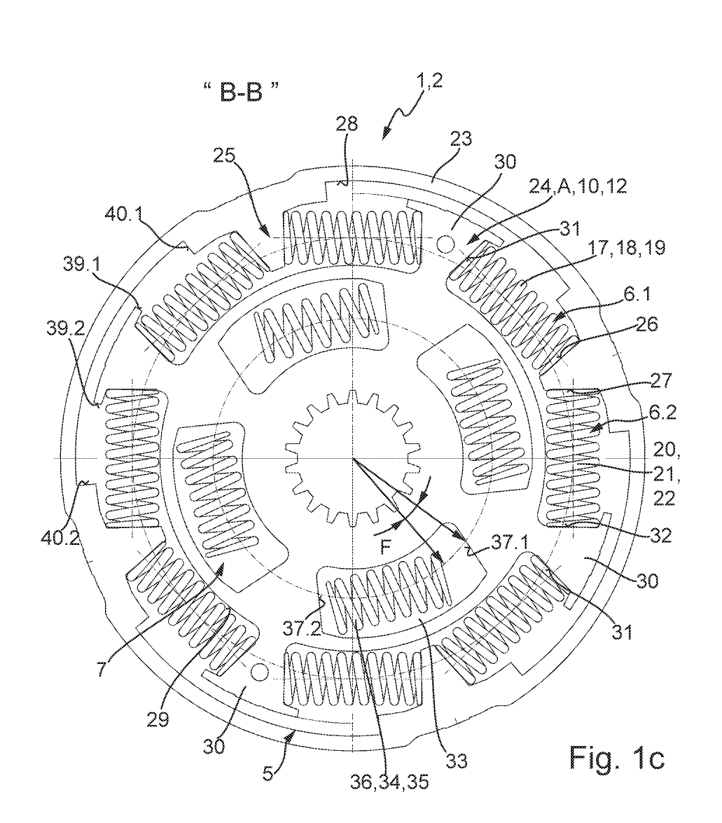

FIG. 2 illustrates a simplified schematic of a side view of the side discs in the form of the drive discs 9.1 and 9.2 of the device 1 according to FIG. 1. A disc shaped configuration in the form of an annular disc with openings 41 configured in circumferential direction is also visible for receiving the spring units 19 and 22 of the dampers 6.1 and 6.2, and also supports in circumferential direction and in radial direction are visible. Analogously thereto, the drive discs comprise openings 42 for the second damper assembly 7, which are configured on a smaller diameter and which receive the spring unit 36.

The embodiment according to the invention according to FIGS. 1 and 2 is characterized by a high degree of functional concentration, a high level of compactness and simultaneously a small number of components. It is furthermore possible in this configuration to configure a torsion vibration damper with minimum spring constant which comprises a maximum relative rotation angle with low friction. This is also implemented in that preferably the series damper assembly is disposed on the largest diameter.

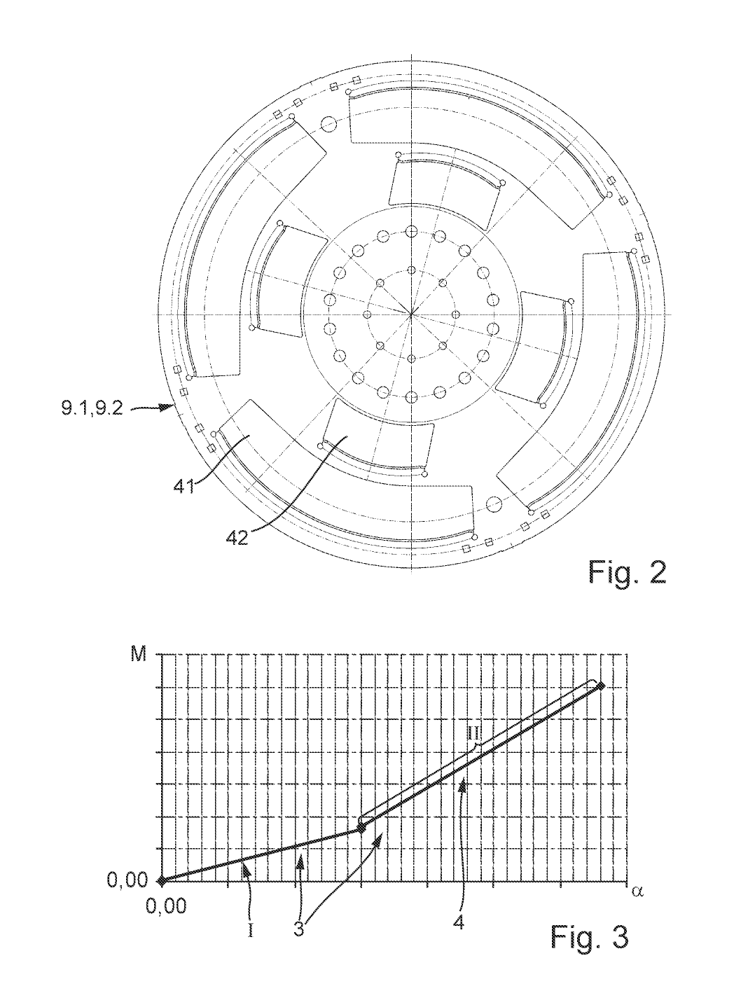

FIG. 3 illustrates the characteristic diagram for the entire damper unit based on a relative rotation angle-/torque diagram α/M. This indicates that the characteristic diagram is flatter in a first relative first rotation angle range, which is characterized by a small relative rotation angle and low torques, and that the characteristic diagram rises when the second damper stage is added. The first portion is designated I and the second portion is designated II.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

### REFERENCE NUMERALS AND DESIGNATIONS

1 vibration damping device
2 multistage series-/parallel damper
3 first damper stage
4 second damper stage
5 damper assembly
6.1, 6.2 damper
7 damper assembly
8 input component
9.1, 9.2 drive discs
10 output component
11 input component
12 output component
13 input component
14 output component
15 input component
16 output component
17 torque transmission devices
18 damping coupling devices
19 spring unit
20 torque transmission device
21 damping coupling device
22 spring unit
23 intermediary flange
24 flange
25 protrusion
26 stop surface
27 stop surface
28 inner circumference
29 outer circumference
30 protrusion
31 side surface
32 side surface
33 recess
34 torque transmission device
35 damping coupling device
36 spring unit
37.1, 37.2 support surfaces
38 mounting element
39.1, 39.2 stop surface
40.1, 40.2 stop surface
41 opening
42 opening
R rotation axis
M torque
α relative rotation angle
F clearance angle
d diameter
E input component
A output component

What is claimed is:

1. A vibration damping device, comprising:
at least two damper assemblies connected in parallel, disposed coaxially, each damper assembly comprising at least one input component and one output component;
a first damper assembly of the at least two damper assemblies comprising at least two dampers connected in series and coupled through an intermediary flange; and,
a second damper assembly of the at least two damper assemblies configured with relative rotation clearance, wherein the output component of the first damper assembly forms a unit with the output component of the second damper assembly, and the first and the second damper assemblies are radially disposed in radial direction on different diameters.

2. The device according to claim 1, wherein the input components of each of the damper assemblies are formed by a unit.

3. The device according to claim 1, wherein the output component of the first damper assembly is integrally configured with the output component of the second damper assembly.

4. The device according to claim 1, wherein the relative rotation clearance of the second damper assembly is defined by a predefined relative rotation angle defining a clearance angle, between the input component and the output component of the second damper assembly and the relative rotation angle is integrated in the output component of the second damper assembly.

5. The device according to claim 1, wherein the first damper assembly is disposed on a first diameter radially outside of the second damper assembly.

6. The device according to claim 1, wherein the first damper assembly and the second damper assembly are disposed in an axial plane.

7. The device according to claim 1, wherein the first damper assembly and the second damper assembly are disposed in an installed position in an axial direction offset from one another.

8. The device according to claim 1, wherein each damper assembly comprises at least one integral or multi-component input component and an integral or multi-component output component, which are coupled with one another through at least a first device for torque transmission and through at least a second device for damping coupling, and which are rotatable relative to one another in a circumferential direction.

9. The device according to claim 8, wherein the first device for torque transmission and the second device for damping coupling are formed by a unit comprising at least one elastic element or at least one spring unit.

10. The device according to claim 1, wherein the two dampers of the first damper assembly are disposed in an axial direction in a plane.

11. The device according to claim 1, wherein the two dampers of the first damper assembly are disposed on a common diameter in a circumferential direction.

12. The device according to claim 1, wherein the input component of the first damper assembly is connected torque proof with the input component of the second damper assembly.

13. The device according to claim 1, wherein the input component of the first damper assembly and the input component of the second damper assembly are formed by a unit.

14. The device according to claim 1, wherein the input component of the first and second damper assemblies is formed by two disc elements offset from one another in an axial direction, and the output component of the first and second damper assemblies is formed by a flange disposed between the disc elements and configured as an annular disc element.

15. The device according to claim 9, wherein the output component of the first and second damper assemblies is formed by two disc elements offset from one another in an axial direction, and the input component of the first and second damper assemblies is formed by an intermediary flange disposed between the disc elements and configured as an annular disc element.

16. The device according to claim 15, wherein the flange comprises protrusions disposed in a radial direction at an outer circumference, evenly offset from one another in a circumferential direction, and oriented in the radial direction outward, forming stop surfaces in the circumferential direction for the first devices and the second devices, and forming recesses in which the spring unit of the second damper assembly can be supported.

17. The device according to claim 15, wherein the intermediary flange is configured as an annular element with protrusions provided in a radial direction at an inner circumference, which protrusions form recesses in a circumferential direction at the inner circumference, which are open at the edge and form stop surfaces for the spring units at surface portions oriented away from one another.

18. The device according to claim 1, wherein the device is disposed in a force transmission device comprising a hydrodynamic component and a lockup clutch, and the device is connected after the hydrodynamic component or the lockup clutch.

19. The device according to claim 4, wherein the relative rotation angle is in a range of 3° to 50°.
